(19) United States
(12) Patent Application Publication
(10) Pub. No.: US 2026/0293856 A1
(43) Pub. Date: Oct. 1, 2026

(54) LIVESTOCK IDENTIFICATION SYSTEM, APPARATUS AND METHOD

(71) Applicant: YOKOGAWA SAUDI ARABIA COMPANY L.L.C., Al-Khobar (SA)

(72) Inventors: Shiekhah Ali AL Binali, Dammam (SA); Abrar Saeed Al-Amoudi, Dhahran (SA); Abdulrahman Basharat Javaid, Dammam (SA); Koutarou Ogawa, Tokyo (JP)

(21) Appl. No.: 19/091,716

(22) Filed: Mar. 26, 2025

(51) Int. Cl. A01K 29/00; A01K 5/02; A01K 11/00; G06V 10/25; G06V 10/44; G06V 10/74; G06V 10/774; G06V 20/52; G06V 20/62; G06V 30/18; G06V 30/19; G06V 40/10

(52) U.S. Cl. CPC A01K 29/005; A01K 5/02; A01K 11/001; G06V 10/25; G06V 10/44; G06V 10/761; G06V 10/774; G06V 20/52; G06V 20/63; G06V 30/18133; G06V 30/19147; G06V 40/10

(57) ABSTRACT

The present invention relates to a livestock identification system, apparatus, and method. The livestock management system comprises an identification apparatus, a storage module, and a processing module. The identification apparatus identifies livestock using an optical device. The storage module stores a training database, real-time status of the identified livestock, and recommendation algorithms. The processing module is communicatively coupled to the identification apparatus and the storage module. The processing module tracks the health of the livestock and generates recommendations using deep learning algorithms. The system precisely identifies the livestock and improves operational efficiency in big farms.

### FIELD OF THE INVENTION

The present invention discloses monitoring of animals, and more particularly, the invention relates to a system, apparatus, and method to precisely identify a livestock for improving operational efficiency in big farms.

### BACKGROUND

### Interpretation Considerations

This section describes the technical field in detail and discusses problems encountered in the technical field. Therefore, statements in the section are not to be construed as prior art.

### Discussion

The demand for dairy products is growing as the global population continues to rise, creating a need for advancements in livestock farming practices that prioritize sustainability and efficiency, particularly for medium and large-scale farms. Such systems play a crucial role on farms by detecting individual cattle, identifying them by their identification (ID) or name, assessing their health status, generating reports on their condition, and issuing alerts when special health attention is required.

Current livestock identification and health monitoring practices primarily rely on manual observation and physical inspections. These methods are not only time-consuming but also susceptible to human error. Traditional identification techniques, including ear tags and branding, face challenges such as wear and tear or loss, which necessitate constant monitoring and replacement. Moreover, while automated identification methods like Radio Frequency Identification (RFID) and QR codes offer effective solutions, they often come with high costs that may deter adoption among farmers.

The existing systems lack comprehensive integration that combines real-time health monitoring with efficient identification processes. As a result, farmers may struggle with productivity losses due to undetected health issues or inefficient resource use.

The current state of livestock management highlights a pressing need for innovative solutions that can streamline operations while addressing the challenges posed by traditional methods. The integration of automated monitoring systems represents a significant advancement over existing practices. By leveraging technology to monitor livestock health and productivity continuously, farms can achieve greater efficiency and sustainability in their operations.

Therefore, there is a need for livestock identification systems, apparatus, and methods that not only address existing inefficiencies but also effectively identify livestock without requiring constant human oversight.

### SUMMARY

An objective of the present invention is to provide a livestock identification system, apparatus, and method that enables a precise and efficient identification of livestock. The system aims to significantly improve operational efficiency in large-scale agricultural farms by addressing the challenges associated with traditional identification methods.

Yet another objective of the present invention is to enhance the overall accuracy of livestock identification by employing two independent identification methods. This dual approach ensures robustness and reliability in tracking and managing livestock, addressing potential limitations or failures in single-method systems.

Another key objective of the present invention is to provide a livestock identification system, apparatus, and method that requires a limited number of images for livestock identification. This approach aims to eliminate the need for diverse classification methods and reduce the computational burden on processing modules, thereby enhancing the efficiency and practicality of the system.

This and other objectives are achieved by providing the livestock identification apparatus, system, and method with the features in the independent claims. Further advantageous embodiments and improvements of the invention are listed in the dependent claims. Hereinafter, expressions like “. . . aspect according to the invention” or “according to the invention” or similar related to the technical teaching of the broadest embodiment as claimed with the independent claims.

According to a first aspect of the present invention, the present invention discloses a livestock identification apparatus. The livestock identification apparatus comprises a first identification unit, a second identification unit, and at least one processing unit. The first identification unit implements an image processing for a biometric identification of a livestock using a similarity search. The second identification unit performs a physical marker identification of the livestock using a character recognition. The at least one processing unit is communicatively coupled with the first identification unit and the second identification unit to collate the biometric identification and the physical marker identification to determine identity of the livestock and initiate a monitoring process. This integrated approach enhances the accuracy and reliability of livestock identification, supporting efficient management and traceability in big farms.

In an embodiment of the present invention, the first identification unit captures an image of a muzzle of the livestock to perform the biometric identification. By leveraging the unique characteristics of the muzzle, the first identification unit provides a reliable and non-invasive method for the biometric identification, enhancing the overall effectiveness of the livestock identification apparatus.

In another embodiment of the present invention, the second identification unit captures an image of an ear tag containing a unique character or symbol affixed to the livestock to perform the physical marker identification. By leveraging ear tags as physical markers, the second identification unit offers a practical and widely adopted method for the livestock identification, enhancing the overall reliability and efficiency of the apparatus. This approach supports seamless integration with the existing livestock management practices, making it easier to implement.

Yet another embodiment of the present invention, the first identification unit processes the image of the muzzle to determine the identity of the livestock by extracting at least one distinctive feature vector from the image of the muzzle and determining whether the at least one distinctive feature vector is present in a memory unit.

In still another embodiment of the present invention, the first identification unit determines if the at least one distinctive feature vector is not present in the memory unit, then the first identification unit is further configured to add the at least one distinctive feature vector into the memory unit. The first identification unit further allocates an index corresponding to the at least one distinctive feature vector and stores the index in the memory unit.

In still another embodiment of the present invention, the first identification unit determines if the at least one distinctive feature vector is present in the memory unit, then the first identification unit is further configured to perform the similarity search to compare the distinctive feature vector with at least one pre-stored feature vector in the memory unit. The first identification unit further identifies at least one best match based on the similarity search and retrieves at least one index and similarity score for the at least one best match.

In another embodiment of the present invention, the at least one pre-stored feature vector corresponds to a single distinct muzzle image of the livestock. Additionally, the use of the distinct muzzle image as an identifier provides a reliable and non-invasive means of identification, making it suitable for widespread adoption across various farming practices.

In yet another embodiment of the present invention, the second identification unit processes the image of the ear tag to determine the identity of the livestock by detecting and localizing an area of interest within the image of the ear-tag. The second identification unit further extracts an alphanumeric information from the localized ear-tag image and determines whether the alphanumeric information is present in a memory unit.

In still another embodiment of the present invention, the second identification unit determines if the alphanumeric information is not present in the memory unit, then the second identification unit is configured to add the alphanumeric information into the memory unit. Further, the second identification unit allocates an index corresponding to the alphanumeric information and stores the index in the memory unit.

In still another embodiment of the present invention, the second identification unit determines that if the alphanumeric information is present in the memory unit, then the second identification unit is further configured to retrieve at least one ear tag index corresponding to the alphanumeric information from the memory unit.

In yet another embodiment of the present invention, the processing unit initiates the monitoring process to optimize an auto feeder unit for determining health and feed intake of the livestock. This data-driven approach enables the early identification of illnesses, minimizes feed waste through precision dispensing, and enhances overall herd productivity by correlating intake trends with health indicators like weight gain, activity levels, or biomarkers. The apparatus may further connect to farm management platforms to generate actionable insights, automate veterinary alerts, or refine feeding protocols for improved livestock welfare and operational efficiency.

In yet another embodiment of the present invention, the processing unit collates output or decisions received from the first and second identification units to determine the identity of the livestock. By employing the two independent identification methods, the overall accuracy of livestock identification is improved.

In yet another embodiment of the present invention, the processing unit assigns a predetermined weightage and priority to output or decision of the first and second identification units during the collation process. By assigning specific weightage, the processing unit ensures that more important or urgent data is prioritized, allowing the optimization of the apparatus's performance and reducing errors. This approach enhances efficiency, particularly in applications where timely and accurate decision-making is crucial. The use of the predetermined weights also allows for flexibility, as they can be adjusted based on changing priorities or new data, ensuring that the apparatus remains adaptable and responsive over time.

In still another embodiment of the present invention, the first and second identification units are integrated into a single unit or separate units. This flexibility allows for customization based on specific requirements or constraints of the application. When integrated into the single unit, the first and second identification units can operate in a streamlined manner, potentially reducing complexity and enhancing efficiency by minimizing the need for inter-unit communication. Conversely, maintaining them as separate units provides the advantage of modularity, allowing for easier maintenance, upgrade, or replacement of individual components without affecting the entire apparatus. This modular approach also facilitates scalability, as additional units can be added as needed to enhance the capabilities of the apparatus or handle an increased workload.

According to a second aspect of the present invention, the present invention discloses a livestock identification system. The system comprises an identification apparatus, a storage module, and a processing module. The identification apparatus identifies livestock using an optical device. The storage module stores a training database, real-time status of the identified livestock, and recommendation algorithms. The processing module is communicatively coupled to the identification apparatus and the storage module. The processing module tracks health of the livestock and generates recommendations using deep learning algorithms. This integrated approach enables the system to monitor livestock health effectively, predict potential issues, and provide actionable insights to improve livestock management and care.

According to a third aspect of the present invention, the present invention discloses a method of identifying livestock from an image. The method comprises the steps of: a) receiving a first image of a livestock animal, including a muzzle pattern; b) extracting a first set of features from the muzzle pattern using a pre-trained model; c) creating a training index and storing the first set of features in a memory unit; d) receiving a second image of the livestock animal; e) adding the second image to the training index by extracting a second set of features from the second image using the pre-trained model; and f) comparing the first image and the second image in the training index based on a closest distance between the first set of features and the second set of features in the memory unit to identify the livestock animal without retraining the pre-trained model; or g) creating a new index for a new livestock animal without retraining the pre-trained model if none of the present index features matches the second set of features. This comparison allows for the identification of the livestock animal without necessitating any retraining of the pre-trained model, thus streamlining the identification process while maintaining high accuracy and efficiency.

In an embodiment of the present invention, the method further comprises the steps of: a) receiving a first ear tag image of the livestock animal; b) extracting an alphanumeric information from the first ear tag image using the pre-trained model; c) creating a training index and storing the alphanumeric information in the memory unit; d) receiving a second ear tag image of the livestock animal; e) adding the second ear tag image to the training index by extracting an alphanumeric information from the second ear tag image using the pre-trained model; and f) comparing the alphanumeric information from the first and second ear tag images in the training index to identify the livestock animal based on numerical digits matching; or g) creating a new index for a new livestock animal without retraining the pre-trained model if the numerical digits do not match. This approach ensures efficient and accurate identification while allowing for seamless integration of new animals into the system.

Further objectives, features, and advantages of the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

Various aspects, as well as embodiments of the present invention, are better understood by referring to the following detailed description. To better understand the invention, the detailed description should be read in conjunction with the drawings.

FIG. 1A illustrates a livestock identification apparatus in accordance with an embodiment of the present invention;

FIG. 1B illustrates a livestock identification apparatus in accordance with another embodiment of the present invention;

FIG. 2 illustrates a livestock identification system in accordance with an embodiment of the present invention;

FIG. 3 illustrates a method flow for a livestock identification system in accordance with an exemplary embodiment of the present invention;

FIG. 4 illustrates a method flow for a livestock identification in accordance with an embodiment of the present invention; and

FIG. 5 illustrates a method flow for identifying livestock from an image in accordance with an embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

FIG. 1A illustrates a livestock identification apparatus 100 in accordance with an embodiment of the present invention. The livestock identification apparatus 100 comprises a first identification unit 102, a second identification unit 104, a communication unit 106, a processing unit 108, a memory unit 110, an auto feeder unit 112, a display unit 114, and an alert unit 116.

The first identification unit 102 performs a biometric identification of the livestock. The biometric identification includes capturing an image of a muzzle of the livestock. The terms “muzzle pattern”, “muzzle”, “muzzle print” are used interchangeably herein and refer to the unique pattern formed in the epidermis layer of the skin on the muzzle region of animals. The muzzle pattern or nose print is specific for each animal and could be used as a unique identification, just like a fingerprint for human beings. This unique pattern becomes fixed right after the birth of the animal, and not even twin animals would ever have the same exact muzzle pattern. The muzzle print includes the visual characteristics of the livestock, such as textures, shapes, and semantic information.

The first identification unit 102 includes at least one an optical sensor, a depth sensor, or a combination thereof. The optical sensor or depth sensor may include one or more cameras. The first identification unit 102 captures the muzzle pattern of the livestock from different angles.

The livestock includes but is not limited to cattle, cows, dairy cows, bulls, calves, pigs, sows, boars, piglets, horses, sheep, goats, or deer.

The first identification unit 102 implements image processing for the biometric identification of the livestock. The first identification unit 102 processes the image of the muzzle print to determine the identity of the livestock. Alternatively, the first identification unit 102 may implement a pre-trained model utilizing deep learning algorithms to identify the livestock.

The first identification unit 102 extracts at least one distinctive feature vector from the muzzle image. The first identification unit 102 utilizes a distillation with no labels-vision transformer (DINO) or contrastive language-image pre-training (CLIP) model to extract the at least one distinctive feature from the muzzle image and convert the extracted feature into a vector. These models leverage self-supervised learning and contrastive learning techniques to extract robust features without requiring labeled data, making them ideal for complex visual data like muzzle patterns.

The DINO model compares different views of the same image to learn informative representations, while the CLIP model aligns visual and textual representations to extract features that can be aligned with textual descriptions. Once extracted, the feature is converted into the distinctive feature vector that captures unique characteristics of the muzzle image, such as textures and shapes. This approach ensures high accuracy and efficiency in the livestock identification, as the approach reduces the need for extensive labeled datasets and adapts well to diverse muzzle patterns and environmental conditions. By utilizing these advanced models, the first identification unit 102 can effectively extract and convert the feature into the vector, facilitating precise and efficient livestock identification.

The first identification unit 102 determines whether the at least one distinctive feature vector is present in the memory unit 110 (explained below in detail). If the at least one distinctive feature vector is not present in the memory unit 110, then the first identification unit 102 adds the at least one distinctive feature vector into the memory unit 110. The first identification unit 102 allocates an index corresponding to the at least one distinctive feature vector and stores the allocated index in the memory unit 110. The allocation and storage of indices facilitate quick retrieval and identification of livestock in future operations, supporting efficient farm management and traceability.

If the first identification unit 102 determines that the at least one distinctive feature vector is present in the memory unit 110, then the first identification unit 102 performs a similarity search to compare the extracted distinctive feature vector with at least one pre-stored feature vector in the memory unit 110 to identify at least one best match. The similarity search is performed based on the closest distance between the at least one distinctive feature and the muzzle features stored in the memory unit 110. In one example, the similarity search algorithm is a Facebook artificial intelligence similarity search (FAISS) algorithm, which is known for its efficiency in high-dimensional vector searches. Further, the first identification unit 110 retrieves at least one index and similarity score for the at least one best match stored in the memory unit 110. The first identification unit 102 selects the top k indices corresponding to the best matches based on the similarity search. In one example case, k=0,1,2,3 . . . n. This approach allows for flexible and precise identification by considering multiple potential matches and selecting those that are most similar to the input features.

In another example, if the memory unit 110 contains only one muzzle image of the livestock, then the first identification unit 102 selects only one index based on the similarity search. In this case, the result is a single index that corresponds to the best match, which is then used for the livestock identification purposes.

The similarity search employed by the first identification unit 102 avoids dimensional issues faced by traditional classification methods, as the similarity search involves the index search rather than creating a separate dimension for each class of livestock animal, such as cows. This approach is particularly advantageous in real-time applications, where speed and efficiency are important. Unlike conventional classification methods, which can be computationally intensive and time-consuming, the index search process is fast and well-suited for real-time scenarios.

Moreover, the apparatus 100 is robust even when the number of images available for each class is limited. The apparatus 100 effectively compares the feature vectors and provides the top-k results, ensuring that the quality of the results is not compromised by limited data. This capability is especially beneficial in situations where collecting extensive datasets for each animal may be challenging.

Another significant advantage of this apparatus 100 is the flexibility and easy updating. When adding a new livestock animal (cow) to the memory unit 110, there is no need to retrain the model, which is a common requirement in traditional classification-based methods. Instead, the apparatus 100 simply adds some images of the new animal to the memory unit 110 to build or update a training index or database in the memory unit 110. This eliminates the complexity and computational overhead associated with retraining models and makes it easier to manage.

The second identification unit 104 performs a physical marker identification of the livestock. The physical marker identification includes capturing an image of an ear tag using character recognition. The character recognition includes recognizing a unique character, symbol, or number affixed to the livestock. The unique character, symbol, or number affixed to the livestock may include an alphanumeric information. The second identification unit 104 may include at least one an optical sensor, a depth sensor, or a combination thereof. The optical sensor or depth sensor may include one or more cameras. The second identification unit 104 captures the ear tag of the livestock from different angles. This approach effectively mitigates the challenges of low accuracy encountered under diverse conditions, such as varying lighting and tag visibility, thereby enhancing the reliability of ear tag identification.

The second identification unit 104, processes the ear tag image to determine the livestock's identity through a two-step process: ear tag detection and number or alphanumeric character recognition. The second identification unit 104 applies pre-processing techniques to enhance the ear tag image quality. This involves applying a Gaussian blur and a smoothing technique that reduces noise by averaging pixel values, thereby making the ear tags more distinguishable against the background by removing high-frequency noise. Subsequently, contrast stretching is applied to enhance the ear tag image's contrast by expanding the range of intensity values, which makes features like ear tags more prominent and facilitates better detection by the model. These pre-processing steps are followed by object detection methods to locate the ear tags within the image.

The second identification unit 104 utilizes a pre-trained model based on advanced deep-learning algorithms to perform ear tag detection with high accuracy and efficiency. Examples of the pre-trained models include convolutional neural networks (CNNs), residual networks, and feature extraction neural networks. Additionally, the apparatus 100 employs the You Only Look Once (YOLO) algorithm, specifically versions such as YOLOv3, YOLOv4, YOLOv7, and YOLOv8. Among these, YOLOv8n stands out as a state-of-the-art object detection model known for its exceptional speed and accuracy. This variant of YOLOv8 is particularly optimized for resource-constrained environments, such as real-time applications on edge devices. Despite its compact size, YOLOv8n delivers robust performance in detecting objects, making the model highly suitable for livestock management apparatus 100 which requires precise and efficient ear tag detection under real-time conditions.

The number recognition process involves two stages: pre-processing and recognition. In the pre-processing stage, the second identification unit 104 crops the captured ear tag image using bounding boxes provided by the detection model to localize an area of interest. Then, the second identification unit 104 filters out unclear images by assessing their fuzziness, eliminating the images with poor quality or excessive noise. The images are resized to uniform pixels and converted to grayscale to simplify the data and focus on the alphanumeric information. Additionally, edge-sharpening is applied to enhance the clarity of the numbers for subsequent recognition. In the recognition stage, the second identification unit 104 employs an optical character recognition (OCR) algorithm, such as PaddleOCR, to efficiently and accurately identify the text or the alphanumeric information in the processed ear tag image. Once recognized, the second identification unit 104 checks if the alphanumeric information is present in the memory unit 110. If not, the second identification unit 104 adds the alphanumeric information to the memory unit 110, allocates a corresponding index, and stores the index in the memory unit 110 for future reference.

If the second identification unit 104 determines that the alphanumeric information is present in the memory unit 110, the second identification unit 104 retrieves at least one ear tag index corresponding to the alphanumeric information from the memory unit 110.

The second identification unit 104 may compare the recognized text or the alphanumeric information with the recognized text or the alphanumeric information in the memory unit 110 to identify the livestock.

Further, the second identification unit 104 selects the exact match ear tag indices retrieved from the memory unit 110.

In one case, the first identification unit 102 and the second identification unit 104 may be installed at feeding or milking stations to capture key areas like the back, loin, tailhead, paralumbar fossa (the hunger groove) or other anatomical features of the livestock.

In another example, if the memory unit 110 contains only one ear tag image of the livestock, then the second identification unit 104 selects only one index corresponding to the ear tag image retrieved from the memory unit 110.

Both the first identification unit 102 and the second identification unit 104 identify the livestock using a limited number of images. This solves a common issue with the need to have several images for livestock to be classified correctly, which is hard to have in medium to large farms. The first identification unit 102 and the second identification unit 104 avoid utilizing classification due to the needed number of images to classify correctly and the dimensionality curse. Thereby reducing the computational efforts required for the processing and analysis and its negative effect on the overall performance.

The first identification unit 102 and the second identification unit 104 are communicatively coupled to the processing unit 108 using a communication unit 106. The communication unit 106 may support any number of suitable wired or wireless data communication protocols, techniques, or methodologies, including but not limited to an ethernet (IEEE 802.3), radio frequency (RF), infrared (IrDA), Bluetooth, ZigBee (and other variants of the IEEE 802.15 protocol), a wireless fidelity Wi-Fi or IEEE 802.11 (any variation), IEEE 802.16 (WiMAX or any other variation), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication.

The processing unit 108 receives the muzzle index from the first identification unit 102 and the ear tag index from the second identification unit 104. The processing unit 108 may comprise a single or multi-core processor. The processing unit 108 executes software instructions or algorithms to implement functional aspects of the present invention. The processing unit 108 may be coupled with a cloud server to receive livestock identification instructions. The processing unit 108 may also be implemented as a digital signal processor (DSP), a microcontroller, a designated system on chip (SoC), an integrated circuit implemented with a field programmable gate array (FPGA), an application-specific integrated circuit (ASIC), or a combination thereof. The processing unit 108 can be implemented using a co-processor for complex computational tasks. The processing unit 108 is integrated with the memory unit 110. The processing unit 108 utilizes logic stored in the memory unit 110 to execute and control any number of operations simultaneously. The processing unit 108 may include one or more specialized hardware, software, and/or firmware modules (not shown) specially configured with particular circuitry, instructions, algorithms, or data to perform functions of the disclosed methods. The processing unit 108 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the present invention.

The memory unit 110 stores the one or more muzzle indices and the one or more ear tag indices corresponding to each animal of the livestock. The one or more muzzle indices and the one or more ear tag indices are stored corresponding to the muzzle features and the extracted alphanumeric information, respectively. Alternatively, the memory unit 110 may store a training index or database, created using the at least one distinctive feature of the muzzle pattern image or the alphanumeric information of the ear tag image.

The term “one or more” and “at least one” is interchangeably used throughout the description and refer to the same meaning.

The memory unit 110 may include any of the volatile memory elements (for example, random access memory, such as Dynamic Random Access Memory (DRAM), Static Random Access Memory (SRAM), Synchronous Dynamic Random-Access Memory (SDRAM), etc.), non-volatile memory elements (for example, Read-only memory (ROM), hard drive, etc.), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a Compact Disc Read-Only Memory (CD-ROM) or other optical data storage medium, any physical medium with patterns of holes, a non-transitory computer-readable medium, Random-access memory (RAM), a Programmable Read-Only Memory (PROM), and Erasable Programmable Read-Only Memory (EPROM), a Flash-Erasable Programmable Read-Only Memory (EPROM), other flash memory, Non-Volatile Random-Access Memory (NVRAM), a cache, a register, other memory chip or cartridge, or networked versions of the same. The memory unit 110 may have a distributed architecture, where various components are situated remotely from one another but can be accessed by the processing unit 108. The memory unit 110 may include one or more software programs or algorithms (machine or deep learning algorithms), body conditioning scoring (BCS) features and corresponding scores, Rumen Fill Scoring (RFS) features and corresponding scores and feeding correlation, each of which includes an ordered listing of executable instructions for implementing logical functions.

In one example, the processing unit 108 determines whether the retrieved ear tag index corresponds to the muzzle index. If the processing unit 108 determines that the ear tag index corresponds to the muzzle index, then the processing unit 108 correctly identifies the livestock. If the processing unit 108 determines that the ear tag index does not correspond to the muzzle index, then the processing unit 108 repeats the livestock identification process for a predefined time interval and if no matching ear tag index is found corresponding to the muzzle index within the predefined time interval, then the processing unit 108 stores the at least one extracted distinctive feature corresponds to the alphanumeric information into the memory unit 110. The predefined time interval is stored in the memory unit 110. In one example, the predefined time interval is 5 minutes, 10 minutes, 15 minutes, or 20 minutes.

After the successful livestock identification, the processing unit 108 initiates a monitoring process to optimize the auto feeder unit 112. The processing unit 108 may utilize the machine learning algorithms to extract and analyze features relevant to the Body Condition Scoring (BCS), such as fat deposits, skeletal landmarks, and other anatomical characteristics. A predefined dataset containing BCS features, and their corresponding scores is stored in the memory unit 110. The processing unit 108 compares the extracted BCS features with the predefined dataset to determine the corresponding body condition score for the livestock. Similarly, the processing unit 108 may implement machine learning algorithms to extract and analyze features related to the Rumen Fill Scoring (RFS), focusing on anatomical indicators such as the paralumbar fossa (the hunger groove) or other relevant regions of the livestock. A predefined set of the rumen fill features, and their corresponding scores is stored in the memory unit 110. The processing unit 108 compares the extracted rumen fill features with the predefined dataset to determine the corresponding rumen fill score. This approach enables precise and automated scoring, facilitating real-time monitoring of livestock health and feed intake.

The processing unit 108 is communicatively coupled to the auto feeder unit 112, which determines the health and feeding intake of livestock based on the BCS, RFS, and feeding correlations. In one example, the feeding correlation is the amount of feed=a*milk yields+b*age. Adding BCS to this equation makes the equation more precise, for example, The mount of feed=a*milk yields+b*age+c*BCS. The auto feeder unit 112 optimizes feed allocation and health monitoring by implementing threshold-based protocols, for example, the auto feeder unit 112 reduces feed when the BCS exceeds 4.0 and the RFS exceeds 4 to prevent overconsumption. Additionally, any deviations from recommended intake levels trigger early disease alerts through apparatus 100. This proposed apparatus 100 combines vision-based scoring, machine learning predictions, and feeder telemetry, aligning with current trends in precision livestock farming for enhanced efficiency and animal welfare.

The auto feeder unit 112 is an advanced unit designed to automate and optimize the feeding process in livestock farming, addressing challenges such as labor shortages, feed efficiency, and animal welfare. The apparatus 100 uses precision feeding technologies to deliver the right amount of feed tailored to each animal's needs, based on factors like production levels, age, and health metrics such as Body Condition Score (BCS) and Rumen Fill Score (RFS). Equipped with the sensors, and the machine learning algorithms, the auto feeders ensure consistent and timely feed distribution while minimizing waste. The auto feeder unit 112 operates autonomously to mix and deliver Total Mixed Rations (TMR) multiple times a day, maintaining feed freshness and preventing overconsumption. Additionally, the auto feeder unit 112 often includes integrated weighing systems for precise rationing and may trigger alerts for deviations in feeding behavior, enabling early disease detection. By reducing manual labor and improving feeding accuracy, the auto feeder unit 112 enhances productivity, promotes animal health, and aligns with modern precision livestock farming practices.

The processing unit 108 collates output or decisions received from the two independent identification units (102, 104) to determine the identity of the livestock. The processing unit 108 assigns a predetermined weightage and priority to the output or decision of the first and second identification units (102, 104) during the collation process. The predetermined weight and the priority are stored in the memory unit 110 of the apparatus 100. Examples of the predetermined weightage to the first and second identification units (102, 104) include but are not limited to 50:50, 40:60, 30:70, 20:80 or 10:90, or vice versa. The processing unit 108 determines the priority based on the predetermined weightage. The memory unit 110 may also store a complete history of the identified livestock.

The processing unit 108 may be communicatively coupled with the display unit 114 to display a message for the failed or successful identification of the livestock. The display unit 114 may include but is not limited to a liquid crystal display (LCD), a light-emitting diode (LED) screen, an organic light-emitting diode (OLED) screen, or another display device.

The processing unit 108 may be communicatively coupled with the alert unit 116 to inform the user about the failed identification of the livestock.

In one example, the livestock identification apparatus 100 is a mobile phone. The mobile phone includes a first identification unit 102, such as the front-facing camera, configured to capture biometric data using image processing, and a second identification unit 104, such as the rear-facing camera (104), adapted for scanning physical markers via optical character recognition. Additionally, the communication unit 106, such as at least one multiband antenna fixed at the top end of the mobile phone that supports both wired and wireless communication protocols, enables data transmission between internal units of the apparatus 100. The processing unit 108 is a system-on-chip (SoC) containing a CPU, GPU, and NPU to execute image processing and machine learning algorithms. The memory unit 110 consists of non-volatile flash storage holding executable instructions and a database of livestock. The display unit 114 is a capacitive touchscreen showing real-time identification results, while the alert unit 116 is a multipurpose speaker producing distinct tones for successful or failed identifications.

FIG. 1B illustrates a livestock identification apparatus 100 in accordance with another embodiment of the present invention. The livestock identification apparatus 100 comprises a first identification unit 102, a second identification unit 104, a communication unit 106, a processing unit 108, a memory unit 110, an auto feeder unit 112, a display unit 114, and an alert unit 116. The only difference between FIG. 1A and FIG. 1B is that the first and second identification units (102, 104) are integrated as a single unit in FIG. 1B. Apart from the integration of the first and second identification units (102, 104), the structure and functionality of the apparatus 100 of FIG. 1B is the same as the apparatus 100 as mentioned above in FIG. 1A.

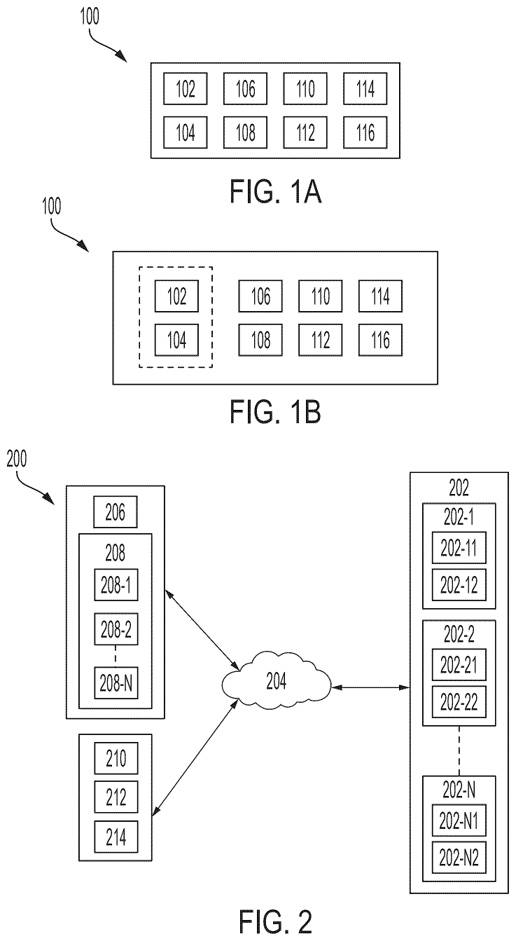

FIG. 2 illustrates a livestock identification system 200 in accordance with an embodiment of the present invention. The system 200 comprises one or more identification apparatus (202-1, 202-2, . . . ,202-n), a communication module 204, a processing module 206, a storage module 208, an auto feeder module 210, a display module 212, and an alert module 214.

The one or more identification apparatus (202-1, 202-2 . . . ,202-n) identify livestock using an optical device. The optical device may include one or more cameras. Each of the one or more identification apparatus (202-1, 202-2, . . . ,202-n) may include one or more identification units (202-11, 202-12, 202-13 . . . 202-1n, 202-21,202-22, 202-23, . . . 202-2n, 202-n1, 202-n2, 202-n3 . . . 202-n-1). In one example, the first identification apparatus 202-1 may include a first identification unit 202-11 and a second identification unit 202-12.

In one example, the first identification unit 202-11 performs a biometric identification of the livestock, including capturing a real-time muzzle image of the livestock. The second identification unit 202-12 performs a physical marker identification of the livestock, including capturing a real-time ear tag image of the livestock using character recognition. The character recognition includes recognizing a unique character, symbol, or number affixed to the livestock.

The first identification unit 202-11 implements a model to extract at least one distinctive feature from the muzzle image. In one example, the model is a distillation with no labels-vision transformer (DINO-ViT) model or contrastive language-image pre-training (CLIP) model. The first identification unit 202-11 implements a similarity search algorithm to compare the extracted distinctive feature of the muzzle with a feature stored within the storage module 208 (explained below in detail) to determine a best match and identify a corresponding muzzle index. The similarity search is performed based on the closest distance between the at least one distinctive feature and muzzle features stored in the storage module 208. In one example, the similarity search algorithm is a Facebook artificial intelligence similarity search (FAISS) algorithm. Further, the first identification unit 202-11 selects top k features based on the similarity matches. In one example case, k=0,1,2,3 . . . n.

Alternatively, if the first identification unit 202-11 does not find any muzzle feature corresponding to the extracted distinctive feature of the muzzle, then the first identification unit 202-11 stores the extracted distinctive feature of the muzzle into the storage module 208 and assigns a muzzle index. Further, the muzzle index is also stored in the storage module 208.

In one example, if the storage module 208 contains only one muzzle image of the livestock, then the first identification unit 202-11 selects the top 1 feature based on the similarity matches.

The second identification unit 202-12, processes the image of the ear tag to determine the identity of the livestock. The second identification unit 202-12 may implement a pre-trained model utilizing deep learning algorithms to identify the livestock. Examples of the pre-trained models include convolutional neural networks (CNNs), residual networks, and feature extraction neural networks. Additionally, the system 200 employs the You Only Look Once (YOLO) algorithm, specifically versions such as YOLOv3, YOLOv4, YOLOv7, and YOLOv8. Among these, YOLOv8n stands out as a state-of-the-art object detection model known for its exceptional speed and accuracy. This variant of YOLOv8 is particularly optimized for resource-constrained environments, such as real-time applications on edge devices. Despite its compact size, YOLOv8n delivers robust performance in detecting objects, making the model highly suitable for the livestock identification system 200 that requires precise and efficient ear tag detection under real-time conditions.

The second identification unit 202-12 implements the YOLO algorithm on the ear tag to detect and localize an area of interest within the ear-tag image. Further, the second identification unit 202-12 employs an optical character recognition (OCR) algorithm to extract alphanumeric information from the detected ear-tag image. The second identification unit 202-12 may further crop and grayscale the ear tag image and apply an edge sharpening filter before applying the optical character recognition algorithm. The optical character recognition algorithm is a paddle optical character recognition. The second identification unit 202-12 retrieves an ear tag index based on the extracted alphanumeric information from the storage module 208. Further, the second identification unit 202-12 retrieves the exact match ear tag indices retrieved from the storage module 208. In another example, if the storage module 208 contains only one ear tag image of the livestock, then the second identification unit 202-12 retrieves the one ear tag index retrieved from the storage module 208.

Alternatively, if the second identification unit 202-12 does not find any ear tag index corresponding to the alphanumeric information in the storage module 208, then the second identification unit 202-12 stores the alphanumeric information of the ear tag in the storage module 208, assigns an ear tag index and stores the index in the storage module 208.

The structure and functionality of the remaining apparatus (202-2,202-3 . . . 202-n) is the same as discussed above for the first identification apparatus 202-1 and also discussed in detail in FIG. 1.The one or more apparatus (202-1, 202-2,202-3 . . . 202-n) may include one or more identification units ((202-11,202-12 . . . 2021n), (202-21,202-22, . . . 202-2n), (202-31,202-32, . . . 202-3n) . . . (202-n1,202-n2, . . . 202-nn) (not shown).

The one or more identification apparatus (202-1, 202-2,202-3 . . . 202n) may be implanted at the same site or different sites.

The one or more identification apparatuses (202-1, 202-2,202-3 . . . 202n) are communicatively coupled to the remotely placed processing module 206 using the communication module 204. The communication module 204 may support any number of suitable wired or wireless data communication protocols, techniques, or methodologies, including but not limited to an ethernet (IEEE 802.3), radio frequency (RF), infrared (IrDA), Bluetooth, ZigBee (and other variants of the IEEE 802.15 protocol), a wireless fidelity Wi-Fi or IEEE 802.11 (any variation), IEEE 802.16 (WiMAX or any other variation), direct sequence spread spectrum (DSSS), frequency hopping spread spectrum (FHSS), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication.

The processing module 206 receives the muzzle index from the first identification unit 202-1 and the ear tag index from the second identification unit 202-2. The processing module 206 may comprise a single or multi-core processor. The processing module 206 executes software instructions or algorithms to implement functional aspects of the present invention. The processing module 206 can be a cloud server providing livestock identification instructions. The processing module 206 may also be implemented as a digital signal processor (DSP), a microcontroller, a designated system on chip (SoC), an integrated circuit implemented with a field programmable gate array (FPGA), an application-specific integrated circuit (ASIC), or a combination thereof. The processing module 206 can be implemented using a co-processor for complex computational tasks. The processing module 206 is integrated with the storage module 208. The processing module 206 utilizes logic stored in the storage module 208 to execute and control any number of operations simultaneously. The processing module 206 may include one or more specialized hardware, software, and/or firmware modules (not shown) specially configured with particular circuitry, instructions, algorithms, or data to perform functions of the disclosed methods. The processing module 206 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the present invention.

The storage module 208 stores the one or more muzzle indices and the one or more ear tag indices corresponding to each animal of the livestock. The one or more muzzle indices and the one or more ear tag indices are stored corresponding to the muzzle features and the extracted alphanumeric information, respectively. Alternatively, the storage module 208 may store a training index or database, created using at least one distinctive feature using the muzzle pattern or image, the alphanumeric information of the ear tag image.

The storage module 208 may include any of the volatile memory elements (for example, random access memory, such as DRAM, SRAM, SDRAM, etc.), non-volatile memory elements (for example, ROM, hard drive, etc.), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a CD-ROM or other optical data storage medium, any physical medium with patterns of holes, a non-transitory computer-readable medium, RAM, a PROM, and EPROM, a FLASH-EPROM, other flash memory, NVRAM, a cache, a register, other memory chip or cartridge, or networked versions of the same. The storage module 208 may have a distributed architecture, where various components are situated remotely from one another but can be accessed by the processing module 206. The storage module 208 may include one or more software programs, or algorithms (machine or deep learning algorithms), body conditioning scoring (BCS) features and corresponding scores, RFS features and corresponding scores, and feeding correlation, each of which includes an ordered listing of executable instructions for implementing logical functions. The storage module 208 may include one or more memory units (208-1, 208-2 . . . 208-n).

The processing module 206 determines whether the retrieved ear tag index corresponds to the muzzle index. If the ear tag index corresponds to the muzzle index, then the processing module 206 proceeds with a monitoring process to optimize the auto feeder module 210. The processing module 206 may utilize the machine learning algorithms to extract and analyze features relevant to the Body Condition Scoring (BCS), such as fat deposits, skeletal landmarks, and other anatomical characteristics. A predefined dataset containing BCS features, and their corresponding scores is stored in the storage module 208. The processing module 206 compares the extracted BCS features with the predefined dataset to determine the corresponding body condition score for the livestock. Similarly, the processing module 206 may implement machine learning algorithms to extract and analyze features related to the Rumen Fill Scoring (RFS), focusing on anatomical indicators such as the paralumbar fossa (the hunger groove) or other relevant regions of the livestock. A predefined set of the rumen fill features, and their corresponding scores is stored in the storage module 208. The processing module 206 compares the extracted rumen fill features with the predefined dataset to determine the corresponding rumen fill score. This approach enables precise and automated scoring, facilitating real-time monitoring of livestock health and feed intake. The processing module 206 is communicatively coupled to the auto feeder module 210, which determines the health and feeding intake of livestock based on the BCS, RFS, and feeding correlations. The amount of feed=a*milk yields+b*age. Adding BCS to this equation makes the equation more precise, for example, The mount of feed=a*milk yields+b*age+c*BCS. The auto feeder module 210 optimizes feed allocation and health monitoring by implementing threshold-based protocols, for example, the auto feeder module 210 reduces feed when the BCS exceeds 4.0 and the RFS exceeds 4 to prevent overconsumption. Additionally, any deviations from recommended intake levels trigger early disease alerts through system 200. This proposed system 200 combines vision-based scoring, machine learning predictions, and feeder telemetry, aligning with current trends in precision livestock farming for enhanced efficiency and animal welfare.

The auto feeder module 210 is an advanced module designed to automate and optimize the feeding process in livestock farming, addressing challenges such as labor shortages, feed efficiency, and animal welfare. The system 200 uses precision feeding technologies to deliver the right amount of feed tailored to each animal's needs, based on factors like production levels, age, and health metrics such as Body Condition Score (BCS) and Rumen Fill Score (RFS). Equipped with the sensors, and the machine learning algorithms, the auto feeders ensure consistent and timely feed distribution while minimizing waste. The auto feeder module 210 operates autonomously to mix and deliver Total Mixed Rations (TMR) multiple times a day, maintaining feed freshness and preventing overconsumption. Additionally, the auto feeder module 210 often includes integrated weighing systems for precise rationing and may trigger alerts for deviations in feeding behavior, enabling early disease detection. By reducing manual labor and improving feeding accuracy, the auto feeder module 210 enhances productivity, promotes animal health, and aligns with modern precision livestock farming practices.

The processing module 206 tracks the health of the livestock and generates recommendations using deep learning algorithms.

If the ear tag index does not correspond to the identified muzzle index, then the processing module 206 repeats the livestock identification process for a predefined time interval, and if no matching ear tag index is found corresponding to the muzzle index within the predefined time interval, then the processing module 206 stores the at least one extracted distinctive feature and the alphanumeric information into the storage module 208. The predefined time interval is stored in the storage module 208. In one example, the predefined time interval is 5 minutes, 10 minutes, 15 minutes, or 20 minutes.

The processing module 206 collates output or decisions received from the first and second identification units (202-1, 202-2) to determine the identity of the livestock. The processing module 206 assigns a predetermined weightage and priority to the output or decision of the first and second identification units (202-1, 202-2) during the collation process. The predetermined weight and priority are stored in the storage module 208 of the system 200. Examples of the predetermined weightage to the first and second identification units (202-1, 202-2) include but are not limited to 50:50, 40:60, 30:70, 20:80 or 10:90, or vice versa. The processing module 206 determines the priority based on the predetermined weightage. The storage module 208 may also store a complete history of the identified livestock.

The storage module 208 stores a real-time status of the identified livestock, a complete history of the identified livestock, and recommendation algorithms.

The complete structure and the functionality of the processing module 206 and the storage module 208 are the same as the processing unit and memory unit of the FIG. 1, not discussed here to avoid repetition. The only difference is that the processing module 206 receives the data from different identification apparatuses (202-1,202-2,202-3 . . . 202-n) implanted at the different sites.

The processing module 206 may be communicatively coupled with the display module 212 to display a message for the failed or successful identification of the livestock. The display module 212 may include but is not limited to a liquid crystal display (LCD), a light-emitting diode (LED) screen, an organic light-emitting diode (OLED) screen, or another display device.

The processing module 206 may be communicatively coupled with the alert module 214 to inform the user about the failed identification of the livestock.

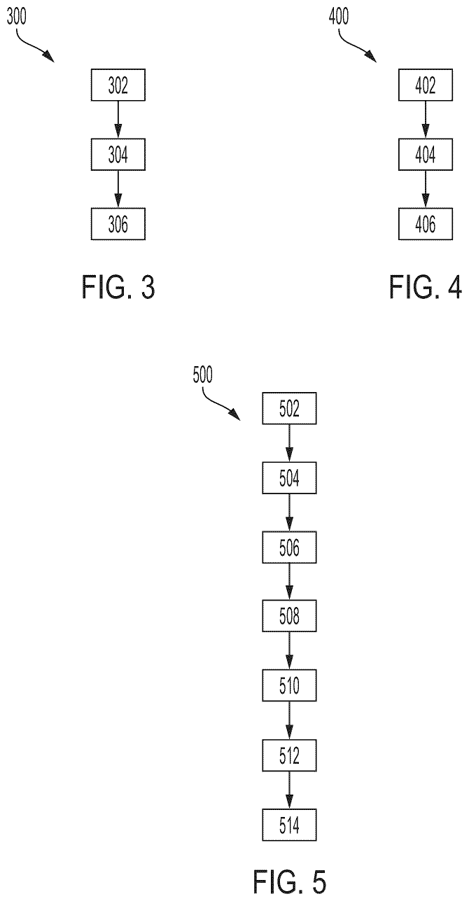

FIG. 3 illustrates a method flow 300 for a livestock identification in accordance with an embodiment of the present invention. The method comprises the steps of a) performing 302 biometric identification of a livestock by implementing image processing and similarity search; b) identifying 304 a physical marker on the livestock by employing character recognition; and c) collating 306 the biometric identification and the physical marker identification to determine the identity of the livestock and initiating a monitoring process.

Performing the biometric identification includes capturing an image of a muzzle of the livestock. The method further processes the image of the muzzle to determine the identity of the livestock by implementing a distillation with no labels-vision transformer (DINO-ViT) model to extract at least one distinctive feature from the muzzle image, and implementing a Facebook artificial intelligence similarity search (FAISS) algorithm to compare the extracted distinctive feature of the muzzle with features, stored within a memory unit to determine a best match and identify a corresponding muzzle index.

Identifying a physical marker includes capturing an image of an ear tag containing a unique character or symbol affixed to the livestock. The method further comprises implementing you only look once (YOLO) algorithm on the ear tag to detect and localize an area of interest within the ear-tag image and employing an optical character recognition (OCR) algorithm to extract an alphanumeric information from the detected ear-tag image; and retrieving an ear tag index based on the extracted alphanumeric information from a memory unit.

The method further determines whether the retrieved ear tag index corresponds to the identified muzzle index, and: (a) if a successful match is determined between the ear tag index and the muzzle index, performing a monitoring process to optimize an auto feeder unit; or (b) if the ear tag index does not correspond to the muzzle index, repeating the livestock identification process for a predefined time interval and c) if no matching ear tag index is found correspond the muzzle index within the predefined time interval, storing the at least one extracted distinctive feature and the alphanumeric information into the memory unit.

The auto feeder unit determines the health and feed intake of the livestock based on the body condition scoring (BCS), rumen fill scoring (RFS), and feeding correlation.

Collating the biometric identification and the physical marker identification further comprises collating output or decisions received from the independent identification units to determine the identity of the livestock.

The method further comprises assigning a predetermined weightage and priority to output or decision of the first and second identification units during the collation process.

FIG. 4 illustrates a method flow 400 for a livestock management in accordance with an embodiment of the present invention. The method comprises the steps of a) identifying 402 a livestock; b) storing 404 a training database, real-time status of the identified livestock, and recommendation algorithms; and c) tracking 406 the health of the livestock and generating recommendations using deep learning algorithms.

The optical device performs biometric and physical marker identification, including capturing a muzzle image and ear tag affixed on the livestock, respectively.

The training database may be used by the machine or deep learning models to optimize livestock management practices.

The real-time status data may include a variety of metrics, such as physiological data (e.g., body temperature, heart rate), behavior patterns (e.g., feeding habits, movement), and environmental conditions (e.g., temperature, humidity).

The health of the livestock is tracked using the machine or deep learning models to detect anomalies, predict potential health issues, and suggest optimal management strategies, such as adjusting feed, modifying environmental conditions, or administering preventative treatments, thereby enabling informed decision-making and improved livestock well-being and productivity.

FIG. 5 illustrates a method flow 500 for identifying livestock from an image in accordance with an embodiment of the present invention. The method 500 comprises the steps of: a) receiving 502 a first image of a livestock animal, including a muzzle pattern; b) extracting 504 a first set of features from the muzzle pattern using a pre-trained model; c) creating 506 a training index and storing the first set of features in the memory unit; d) receiving 508 a second image of the livestock animal; e) adding 510 the second image to the training index by extracting a second set of features from the second image using the pre-trained model; and f) comparing 512 the first image and the second image in the training index based on a closest distance between the first set of features and the second set of features in the memory unit to identify the livestock animal without retraining the pre-trained model; or g) creating 514 a new index for a new livestock animal without retraining the pre-trained model if none of the present index features matches the second set of features.

The method further comprises the steps of: a) receiving a first ear tag image of the livestock animal; b) extracting an alphanumeric information from the first ear tag image using the pre-trained model; c) creating a training index and storing the alphanumeric information in the memory unit; d) receiving a second ear tag image of the livestock animal; e) adding the second ear tag image to the training index by extracting an alphanumeric information from the second ear tag image using the pre-trained model; and f) comparing the alphanumeric information from the first and second ear tag images in the training index to identify the livestock animal based on numerical digits matching; or creating a new index for a new livestock animal without retraining the pre-trained model if the numerical digits do not match.

1. A livestock identification apparatus comprises:
a first identification unit implementing image processing for a biometric identification of a livestock using a similarity search;
a second identification unit for a physical marker identification of the livestock using a character recognition; and
at least one processing unit communicatively coupled with the first identification unit and the second identification unit to collate the biometric identification and the physical marker identification to determine identity of the livestock and initiate a monitoring process.

2. The apparatus according to claim 1, wherein the first identification unit captures an image of a muzzle of the livestock to perform the biometric identification.

3. The apparatus according to claim 1, wherein the second identification unit captures an image of an ear tag containing a unique character or symbol affixed to the livestock to perform the physical marker identification.

4. The apparatus according to claim 2, wherein the first identification unit processes the image of the muzzle to determine the identity of the livestock by:
extracting at least one distinctive feature vector from the image of the muzzle; and
determining whether the at least one distinctive feature vector is present in a memory unit.

5. The apparatus according to claim 4, wherein the first identification unit determines that if the at least one distinctive feature vector is not present in the memory unit, the first identification unit is further configured to:
add the at least one distinctive feature vector into the memory unit;
allocate an index corresponding to the at least one distinctive feature vector; and
store the index in the memory unit.

6. The apparatus according to claim 4, wherein the first identification unit determines that if the at least one distinctive feature vector is present in the memory unit, the first identification unit is further configured to:
perform the similarity search to compare the distinctive feature vector with at least one pre-stored feature vector in the memory unit;
identifying at least one best match based on the similarity search; and
retrieving at least one index and similarity score for the at least one best match.

7. The apparatus according to claim 6, wherein the at least one pre-stored feature vector corresponds to a single distinct muzzle image of the livestock.

8. The apparatus according to claim 3, wherein the second identification unit processes the image of the ear tag to determine the identity of the livestock by:
detecting and localizing an area of interest within the image of the ear-tag;
extracting an alphanumeric information from the localized ear-tag image; and
determining whether the alphanumeric information is present in a memory unit.

9. The apparatus according to claim 8, wherein the second identification unit determines that if the alphanumeric information is not present in the memory unit, the second identification unit is further configured to:
add the alphanumeric information into the memory unit;
allocate an index corresponding to the alphanumeric information; and
store the index in the memory unit.

10. The apparatus according to claim 8, wherein the second identification unit determines that if the alphanumeric information is present in the memory unit, the second identification unit is further configured to retrieve at least one ear tag index corresponding to the alphanumeric information from the memory unit.

11. The apparatus according to claim 1, wherein the processing unit is configured to initiate the monitoring process to optimize an auto feeder unit for determining health and feed intake of the livestock.

12. The apparatus according to claim 1, wherein the processing unit collates output or decision received from the first and second identification units to determine the identity of the livestock.

13. The apparatus according to claim 1, wherein the processing unit assigns a predetermined weightage and priority to output or decision of the first and second identification units during the collation process.

14. The apparatus according to claim 1, wherein the first and second identification units are integrated into a single unit or separate units.

15. A system for livestock management comprising:
an identification apparatus to identify livestock using an optical device;
a storage module to store a training database, real-time status of the identified livestock, and recommendation algorithms; and
a processing module communicatively coupled to the identification apparatus and the storage module; wherein the processing module
tracks health of the livestock and generates recommendations using deep learning algorithms.

16. A method of identifying livestock from an image, the method comprising:
receiving a first image of a livestock animal, including a muzzle pattern;
extracting a first set of features from the muzzle pattern using a pre-trained model;
creating a training index and storing the first set of features in a memory unit;
receiving a second image of the livestock animal;
adding the second image to the training index by extracting a second set of features from the second image using the pre-trained model; and
comparing the first image and the second image in the training index based on a closest distance between the first set of features and the second set of features in the memory unit to identify the livestock animal without retraining the pre-trained model; or
creating a new index for a new livestock animal without retraining the pre-trained model if none of the present index features matches the second set of features.

17. The method of claim 16, further comprises:
receiving a first ear tag image of the livestock animal;
extracting an alphanumeric information from the first ear tag image using the pre-trained model;
creating a training index and storing the alphanumeric information in the memory unit;
receiving a second ear tag image of the livestock animal;
adding the second ear tag image to the training index by extracting an alphanumeric information from the second ear tag image using the pre-trained model; and
comparing the alphanumeric information from the first and second ear tag images in the training index to identify the livestock animal based on numerical digits matching; or
creating a new index for a new livestock animal without retraining the pre-trained model if the numerical digits do not match.
